(19) United States
(12) Patent Application Publication
(10) Pub. No.: US 2005/0265339 A1
(43) Pub. Date: Dec. 1, 2005

(54) Server, contents processor, contents processing system, contents processing method, program for executing contents processing and recording medium for recording the program

(76) Inventor: Hiroki Kato, Kanagawa (JP)

Correspondence Address: KATTEN MUCHIN ROSENMAN LLP, 575 MADISON AVENUE, NEW YORK, NY, 10022-2585, US

(21) Appl. No.: 11/141,266

(22) Filed: May 31, 2005

(30) Foreign Application Priority Data
May 31, 2004 (JP) 2004-160838

(51) Int. Cl. H04L 12/28

(52) U.S. Cl. 370/389

(57) ABSTRACT

A server (3) recognizes a contents transmission request from a terminal (4) and judges whether family tag of the terminal (4) is identical with that of the server (3). Only when the family tag is identical, according to license conditions for executing contents, the contents encoded by the family tag is copied and sent to a contents database (32). When the terminal (4) to which the contents has been previously sent can execute the contents is connected sendably and receivably via communication media (2) to the server (3), the other terminal (4) decodes the encoded contents by the family tag into the contents database (32) for producing streaming output.

### BACKGROUND OF THE INVENTION

1. Field of the Invention

The present invention relates to a server, a contents processor, a contents processing system, a contents processing method, a program for executing contents processing and a recording medium for recording the program for allowing a terminal to execute contents such as video pictures, music and video games that are sent and received via communication media.

2. Description of Related Art

Recently, the Internet has become widely used with the increased use of personal computers. The Internet is a network that covers the whole world. Using the Internet, anyone can easily collect information from all over the world. Web sites providing various contents are connected to the Internet.

Thus, people can get not only simple information but also entertainment contents such as music, video pictures and softwares for video games promptly at home.

Regarding music contents, a method using MP3 (MPEG-1 Audio Layer 3) is widely used for compressing data. Music contents compressed by MP3 can be transmitted over the Internet and stored in any kind of recording media, so that there is a risk that music contents may be copied without limitation to infringe copyrights. To prevent this risk, it is known a method for encoding contents for distribution (see, for instance, Japanese Unexamined Patent Publication No. 2002-207639, page 3 to 11).

In the method disclosed in the publication, contents included in a data group having a one-time password are executed by a predetermined control program, where the contents execution is allowed by a verification authenticator generated from a contents authenticator by a one-way function.

Each time the contents is executed or as the time elapses, information regarding usage frequency is updated and the contents authenticator and verification authenticator are also updated while keeping the relation of the one-way function. When the information regarding usage frequency matches a predetermined usage frequency, the execution of the contents by the control program is restricted.

When, for instance, a CD (Compact Disk) containing music contents is purchased, the music contents can be used without limitation, unless the recording surface of the CD is damaged. On the other hand, in an arrangement disclosed in the above publication in which a certain limitation is placed on contents execution on the basis of usage frequency, it is required to retrieve contents again for further use beyond a predetermined usage frequency.

The above-described arrangement of the publication may be applied in an environment where contents can be transmitted for use within a restricted range such as home networks. In such case, if each family member has a terminal that can execute the contents, it is possible to permit any one of the family members to execute the contents by assigning a contents authenticator to each terminal, where the copyright can be properly protected. However, it is not possible for all of the family members to execute the contents unlike a CD, which is disadvantageous.

### SUMMARY OF THE INVENTION

An object of the present invention is to provide a server, a contents processor, a contents processing system, a contents processing method, a program for executing contents processing and a recording medium for recording the program that can overcome the problems discussed above.

According to a first aspect of the present invention, a server for storing contents and sending various information including the contents via communication media in such a manner that the information can be sent and received and the contents can be executed in at least one terminal connectable to the server includes: a contents storage for storing the contents; a group information storage for storing group information for identifying a group that can execute the contents; a communication-status detector for detecting a status whether the information can be sent to and received from the terminal via the communication media; a contents dispatcher for executably sending the contents only to the terminal stores the group information via the communication media; and a dispatch controller for restricting a contents transmission by the contents dispatcher via the communication media to the other terminal connected in such a manner that the information can be sent and received when the communication-status detector detects that the terminal to which the contents has been sent by the contents dispatcher is not connected in such a manner that the information can be sent and received.

The above-described contents transmission by the contents dispatcher may be performed using following methods.
(1) Copy: when the contents is sent to the terminal, the contents is reproduced solely by the function of the terminal, where the contents remains stored in the contents storage of the server even after the contents is sent to the terminal.
(2) Streaming: when the contents is sent by the server, the contents is partially sent out from the server, where the partially sent contents is sequentially reproduced by the terminal.

In the first aspect of the present invention, the contents is executably sent via the communication media only to the terminal that has the group information for identifying a group such as a family, a company department and a private circle in which the contents can be shared and executed.

When the terminal to which the contents has been sent is not connected in such a manner that the information can be sent and received, the contents is regarded as being taken out, where the transmission of the contents stored in the contents storage to the other terminal connected in such a manner that the information can be sent and received via the communication media is limited.

Accordingly, when the contents allows parallel execution, the stored contents is read and executed by the other terminal using streaming output (sending the contents via the communication media), or, when only a limited number of copy of the contents is allowed, the contents is transferred to the other terminal to allow execution even when the terminal is no connected to the server, thereby appropriately controlling the execution of the contents in accordance with the execution restriction of the contents, so that the contents can be properly protected while improving the convenience for the user.

Further, in the first aspect of the present invention, it is desirable that the subtracted number of the license information is restored, when the communication-status detector detects that the terminal to which the contents having the license information has been sent is connected and the terminal to which the contents has been sent cannot execute the contents.

Hence, when the contents stored in the terminal is corrupted and unexecutable, by restoring by the number of the terminal that is subtracted from the number contained in the license information, in an environment where the contents is appropriately used, it becomes possible to prevent inconvenience such as interruption of the contents, and the contents can be appropriately executed in correspondence with the license information, while improving the usability for the user.

According to a second aspect of the present invention, a contents processor that can be connected to a server storing contents via communication media in such a manner that various information including the contents can be sent and received and that executes the contents sent by the server includes: a terminal information retrieving device for retrieving the information via the communication media; a terminal group information storage for identifying a group that can execute the contents and stores group information corresponding to the group information stored in the server; a terminal contents storage for stores the contents that the terminal information retrieving device has retrieved from the server to which the group information corresponds; and a terminal execution device for reading and executing the contents stored in the terminal contents storage or the contents stored in the server to which the group information corresponds via the communication media.

In the second aspect of the present invention, the contents can be retrieved via the communication media and stored in the terminal contents storage only from the server having the corresponding group information, and the terminal execution device executes the stored contents or executes by reading the contents stored in the server having the corresponding group information via the communication media.

The contents can be executed only within a group that the execution is permitted, and by, for instance, restricting the contents transmission so that the copy-prohibited contents cannot be executed on the other terminal, permitting the other terminal to read and execute the contents by streaming output (the contents is sent via the communication media) when the contents can be parallelly used, or, even if the contents is transferred to the other terminal, permitting the execution such that the contents is not connected when the copiable number of times is predetermined for the contents, the contents execution can be appropriately controlled in accordance with the contents execution limit, thereby appropriately protecting the contents while improving the convenience for the user.

According to a third aspect of the present invention, a contents processing system includes: a server for storing contents and at least one terminal connectable to the server via communication media in such a manner that various information including the contents can be sent and received; and the terminal includes: a terminal sending/receiving device for sending and receiving the various information via the communication media, a terminal contents storage that can store the contents sent by the server, a terminal group information storage for storing group information for identifying a group that can execute the contents, and a terminal execution device for executing the contents; and the server includes: a contents storage for stores the contents, a group information storage for stores the group information, a communication-status detector for detecting a status whether the information can be sent to and received from the terminal via the communication media, a contents dispatcher for sending the contents only to the terminal stores the group information via the communication media in such a manner that the contents can be executed by the terminal execution device, and a dispatch controller for restricting the transmission of the contents by the contents dispatcher via the communication media to the other terminal connected in such a manner that the contents can be sent and received when the communication-status detector detects that the terminal that can execute the contents by the terminal execution device is not connected in such a manner that the information can be sent and received.

In the third aspect of the present invention, the contents stored in the contents storage of the server is sent by the contents dispatcher via the communication media only to the terminal that stores the group information corresponding to the group information for identifying a group that can execute the contents in the group information storage and is stored in the terminal contents storage of the terminal in such a manner that the contents can be executed by the terminal execution device. If the terminal that can execute the contents is not connected, the contents transmission to the other connected terminal is restricted.

Accordingly, by, for instance, permitting the other terminal to read and execute the contents by streaming output (the contents is sent via the communication media) when the contents can be parallelly used, or permitting the execution even if the contents is transferred to the other terminal such that the contents is not connected when the copiable number of times is predetermined for the contents, the contents execution can be appropriately controlled in accordance with the contents execution limit, thereby appropriately protecting the contents while improving the convenience for the user.

According to a forth aspect of the present invention, a contents processing system includes a server according to the above-described first aspect of the present invention; and at least one terminal is connectable via the communication media in such a manner that the various information including the contents can be sent to and received from the server and executes the contents sent from the contents processor.

In the forth aspect of the present invention, to the above-described server of the first aspect of the present invention, at least one of terminal(s) for executing the contents sent from the server is connectable via the communication media.

Thus, even in the system arrangement where the contents is executed on the terminal that is disconnectably connected, the contents execution can be appropriately restricted in correspondence with the contents execution limit, thereby appropriately protecting the contents while improving the convenience for the user.

According to a fifth aspect of the present invention, a contents processing system includes: the contents processor according to the above-described second aspect of the present invention; and a server for executably sending the contents to the contents processor in which at least one contents processor, serving as the terminal, is connectable via the communication media in such a manner that the information including the contents stored thereby is sent and received.

In the fifth aspect of the present invention, the above-described contents processor according to the second aspect is used as a terminal, where a plurality of the contents processor is connectable to the server via the communication media in such a manner that the information including the contents can be sent and received and the contents stored in the server is executably sent by the server.

Thus, even in the system arrangement where the contents is executed on the contents processor that is disconnectably connected to the server, the contents execution can be appropriately limited in correspondence with the contents execution limit, thereby appropriately protecting the contents while improving the convenience for the user.

According to a sixth aspect of the present invention, a contents processing method for sending contents stored in a contents storage in such a manner that various information including the contents is executably sent to and received from at least one terminal via communication media includes steps of: detecting whether the information can be sent to and received from the terminal via the communication media; detecting whether the terminal connected via the communication media has the group information corresponding to the group information for identifying the group that can execute the contents; detecting whether the terminal connected via the communication media executably stores the contents; and limiting the contents transmission via the communication media to the other terminal connected in such a manner that the information can be sent and received when recognizing that the terminal that executably stores the contents is not connected in such a manner that the information can be sent and received.

In the sixth aspect of the present invention, like the above-described first aspect, the contents is executably sent only to the terminal having the group information for identifying a group that can share and execute the contents. If the terminal to which the contents has been sent is not connected, the contents is regarded as being taken out, where the transmission of the contents stored in the contents storage to the connected other terminal is restricted.

Hence, for instance, when the contents can be parallelly used, the contents can be read and executed by the other terminal using streaming output (the contents is sent via the communication media), or when the copiable number of times is predetermined for the contents, the contents execution can be appropriately controlled in accordance with the contents execution limit, thereby appropriately protecting the contents while improving the convenience for the user.

According to a seventh aspect of the present invention, a contents processing method for executing contents sent by a server, in which a terminal can be connected to the server storing the contents via communication media in such a manner that information including the contents can be sent and received includes steps of: detecting whether the information can be sent to and received from the server via the communication media; storing the contents sent by the server that stores the group information corresponding to the group information stored in advance for identifying the group that can execute the contents; reading and executing the stored contents and the contents sent by the server that stores the group information corresponding to the group information via the communication media.

In the seventh aspect of the present invention, like the above-described second aspect, the contents can be retrieved via the communication media only from the server having the corresponding group information and stored in the terminal contents storage, and the terminal execution device executes the stored contents or executes by reading the contents stored in the server having the corresponding group information via the communication media.

Hence, the contents can be executed only within a group that the execution is permitted, and by, for instance, restricting the contents transmission so that the contents that copying is prohibited cannot be executed on the other terminal, permitting the other terminal to read and execute the contents by streaming output (the contents is sent via the communication media) when the contents can be parallelly used, or permitting the execution even if the contents is transferred to the other terminal such that the contents is not connected when the copiable number of times is predetermined for the contents, the contents execution can be appropriately controlled in accordance with the contents execution limit, thereby appropriately protecting the contents while improving the convenience for the user.

According to an eighth aspect of the present invention, in a program for contents processing executed on a computer the computer serves as the above-described server or contents processor of the present invention.

A program according to a ninth aspect of the present invention is for executing the contents, the program executing the above contents processing method by a computer.

In the eighth and ninth aspects of the present invention, the computer serves as the above-described server or contents processor of the present invention or executes the above-described contents processing method of the present invention, so that the contents execution can be easily and appropriately controlled in accordance with the contents execution limit, thereby appropriately protecting the contents while improving the convenience for the user. Alternatively, general-purpose computers can be easily applied, thereby easily obtaining the expansion in use.

A recording medium according to a tenth aspect of the present invention records the program for executing the contents processing, the recording medium recording the program for executing the contents processing in a computer-readable manner.

In the tenth aspect of the present invention, since the above-described program for executing contents processing of the present invention is readably stored in the computer, the computer can serve as the above-described server or contents processor of the present invention or easily execute the above-described contents processing method of the present invention as described above, where the contents execution can be easily and appropriately controlled in correspondence with the contents execution limit, thereby appropriately protecting the contents while improving the convenience for the user. Further, the program can be easily handled, thereby easily obtaining the expansion in the use.

### BRIEF DESCRIPTION OF THE DRAWINGS

FIG. 1 is a diagrammatic illustration schematically showing an arrangement of a contents processing system according to an embodiment of the present invention;

FIG. 2 is a schematic illustration showing a structure of a group database of a server of the contents processing system;

FIG. 3 is a schematic illustration showing a structure of a contents database of the server of the contents processing system;

FIG. 4 is a block diagram schematically showing an arrangement of the server of the contents processing system;

FIG. 5 shows licensed terminals connected to the server, where each terminal can execute contents;

FIG. 6 shows that the terminal in which the contents is stored is not connected to the server, where the other terminals can not execute the contents;

FIG. 7 is a block diagram schematically showing an arrangement of the terminal of the contents processing system;

FIG. 8 is a flowchart explaining how the contents processing system works;

FIG. 9 is another flowchart explaining how the contents processing system works;

FIG. 10 is a schematic illustration explaining how the contents processing system works;

FIG. 11 is still another flowchart explaining how the contents processing system works; and

FIG. 12 is a further flowchart explaining how the contents processing system works.

### DETAILED DESCRIPTION OF PREFERRED EMBODIMENT(S)

An embodiment of the present invention will be described below with reference to the drawings.

[1] System Arrangement

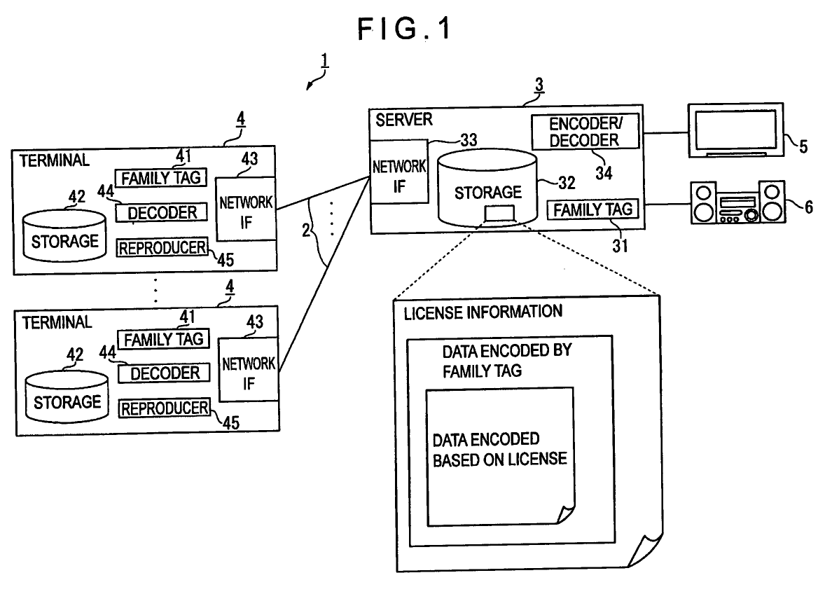

FIG. 1 schematically illustrates an arrangement of a contents processing system 1 according to the present embodiment.

The contents processing system 1 has communication media 2, a server 3 and a terminal (contents processor) 4 also functioning as an execution device, where the contents stored in the server 3 is executed by the terminal 4. The contents may be, for instance, video data such as movies and music videos, image data, music data, voice data, video games and application softwares.

The communication media 2 transmits information between the server 3 and the terminal 4 in such a manner that the server 3 and the terminal 4 can send and receive the data. As transmission media, wireless media such as lights including infrared rays, electric waves, sonic waves and electromagnetic rays, wired media such as signal lines, or networks such as the Internet and telephone lines may be used. Specifically, the communication media 2 may employ any type of communication methods such as ad-hoc connections and the Internet connections by which the server 3 and the terminal 4 can directly send and receive various information via any type of communication media such as wired media, wireless media including infrared rays and telephone line networks, provided that the server 3 and the terminal 4 can send and receive the data.

The server 3 is connected to a network (not shown) such as the Internet, and execution devices such as a TV set 5 and an audio set 6 can be connected to the server 3. The server 3 stores and controls contents distributed via the network and retrieved from the TV set 5 and the audio set 6 such as broadcasted TV contents and contents recorded in recording media, and sends the contents to the terminal 4, the TV set 5 or the audio set 6 when required such that the contents can be executed.

As shown in FIG. 1, the server 3 includes a group database (group information storage) 31, a contents database (contents storage) 32, a network interface (Network IF) 33 and an encoder/decoder 34.

The group database 31 stores family tags for group information. The family tags are used to identify a group allowed to execute contents, i.e. for instance, to set the contents to be executable within a family.

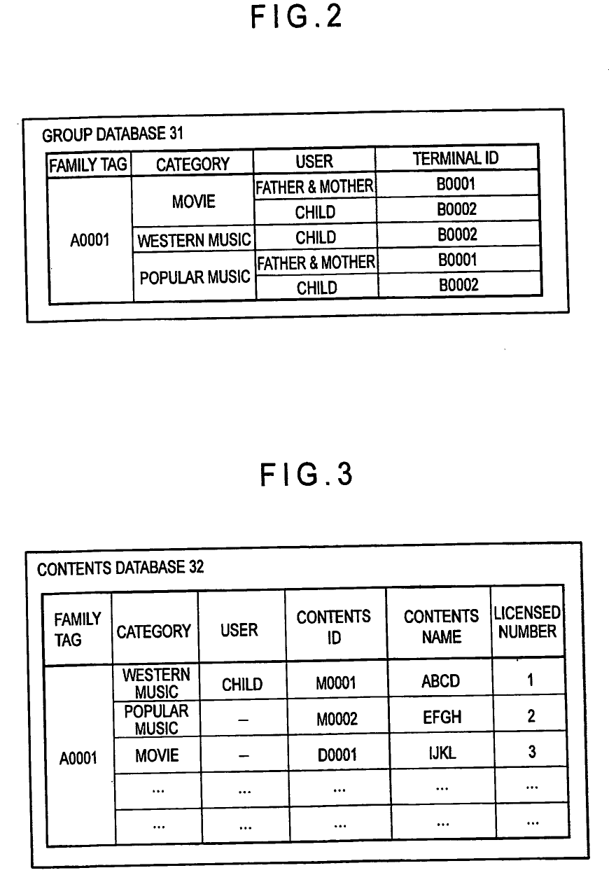

Specifically, as shown in FIG. 2, the group database 31 is a database in which a family tag such as the product number or identification number of the server 3 and identification numbers of the terminals 4 managed by the server 3 are mutually associated. Incidentally, as shown in FIG. 2, in the group database 31, the categories of the contents reproduceable by the terminal 4 and sub family tags representing family relationship (e.g. parent and child, sibling) may be input to further categorize the group in accordance with the contents.

The contents database 32 stores a plurality of contents that can be executed by the terminal 4, the TV set 5 or the audio set 6 in a readable manner. Specifically, as shown in FIG. 3, the contents database 32 is a database in which the family tags of the group database 31 and information of the contents executable for each family tag are mutually associated. To each contents stored in the contents database 32, license information regarding the limitation against contents execution is integrally attached.

The license information may be the number of times the contents can be parallelly executed by execution devices such as the other terminal 4, the TV set 5 and the audio set 6, the number of times the contents can be copied to the execution devices and the period of time in which the contents is available. The license information may be associated with the group information described above, so that the execution limit may be set for each group information. Specifically, the execution limit may be set for each category or sub family tag such as “parent and child” and “sibling”. Incidentally, when the contents is stored in the contents database 32, the contents is encoded by predetermined group information such as the family tag recorded in the group database 31.

The network interface 33 sends/receives the various information including the contents via the communication media 2. The sent/received information includes information for requesting a contents transfer or information for identifying the terminal 4 to receive the contents. The network interface 33 also sends/receives information to/from a server of a web site distributing contents via a network such as the Internet. Further, the network interface 33 can send/receive information to/from an outside execution device, an outside server 3 or an outside terminal 4 via a network such as the Internet and an intranet.

The encoder/decoder 34 encodes contents retrieved via the network or the communication media 2 and decodes the encoded contents. The encoding and decoding are processed by information regarding the group licensed for executing the contents such as the family tag.

The terminal 4 executes the contents stored in the terminal 4 or the contents that are transferred from the server 3. The terminal 4 also can obtain the contents via the network. In addition to a fixed-line device, the terminal 4 may be a portable phone, a portable game console, or a portable personal computer. The terminal 4 includes a terminal group database (terminal group information storage) 41, a terminal contents database (terminal contents storage) 42, a terminal network interface 43, a decoder 44 and a reproducer (terminal execution device) 45.

The terminal group database 41 stores family tags for group information. The group information is associated with the server 3 to/from which the terminal 4 sends/receives information and the family tags (group information) stored in the server 3 are stored. Incidentally as described above, a plurality of sub-family tags can be set for the family tags to hierarchically categorize the group information.

The terminal contents database 42 stores the contents retrieved from the server 3 via the communication media 2 and retrieved in a readable manner from the other servers via the networks.

The terminal network interface 43 sends/receives the various information including the contents via the communication media 2 or sends/receives to/from a server of a web site distributing the contents via the network such as the Internet. Further, the terminal network interface 43 can send/receive the various information to/from an outside execution device, an outside server 3 or an outside terminal 4 via a network such as the Internet and an intranet.

The decoder 44 decodes the encoded contents so that the reproducer 45 can execute the contents. The decoded contents is stored in the terminal contents database 42.

The reproducer 45 executes the contents decoded by the decoder 44 to reproduce images or sounds. Thus, the reproducer 45 reads and reproduces the contents stored in the terminal contents database 42 or sequentially reads and reproduces the contents (i.e. produces streaming output) while receiving the contents via the communication media 2.

[2] Arrangement of Server 3

The details of the internal arrangement of the server 3 will be described.

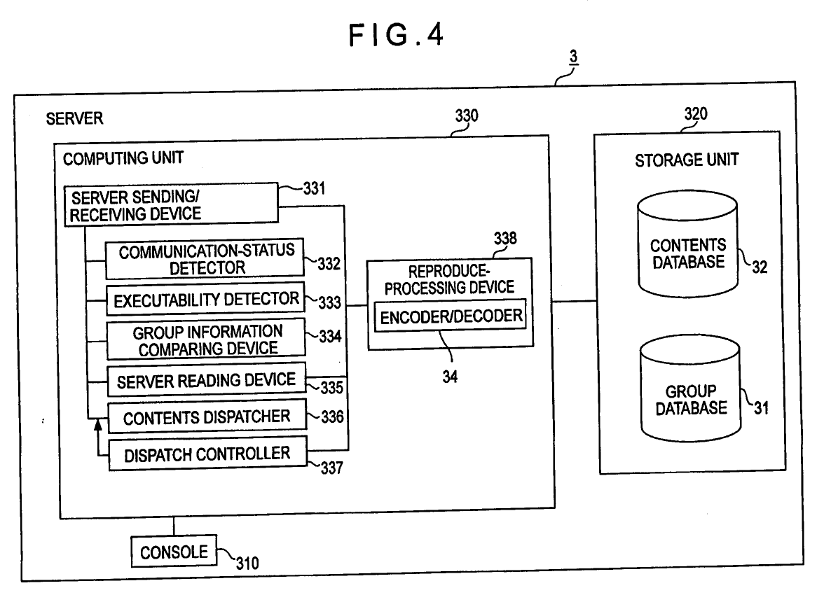

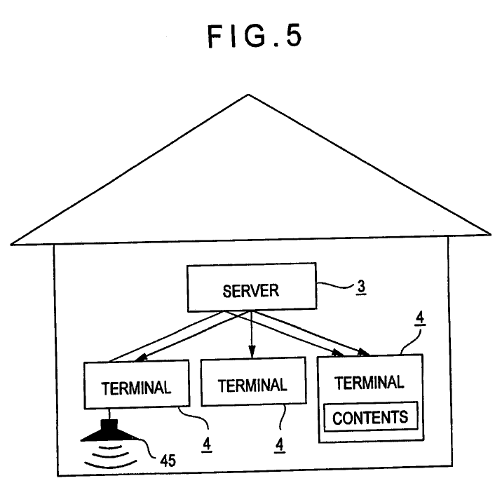

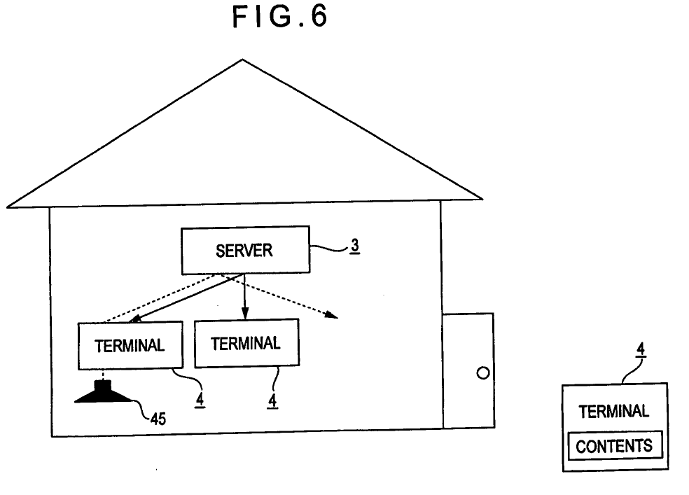

FIG. 4 schematically illustrates the arrangement of the server 3. FIG. 5 shows that the terminals licensed for executing the contents are connected to the server, where each terminal can execute the contents. FIG. 6 shows that the terminal in which the contents is stored is not connected to the server, where the other terminals can not execute the contents.

The server 3 includes a console 310, a storage unit 320 for storing the information and a computing unit 330 (computer) for processing the information.

The console 310 is provided with, for instance, buttons and controls (not shown) to be operated by a user. The user can set various operations of the server 3 through the console 310, such as retrieving the contents distributed from another server, permitting the TV set 5 or the audio set 6 to execute the contents stored in the server 3 and terminals 4, and transferring the contents stored in the terminals 4.

The console 310 outputs signals to the computing unit 330 in response to the user operations on the buttons and controls.

The storage unit 320 retrieves the information including the contents output from the computing unit 330 to store the information. The storage unit 320 is provided with the above-described group database 31 and contents database 32. Incidentally, the storage unit 320 not only stores the group information and contents, but also readably stores the various information to be processed in a memory.

The computing unit 330 sends the information including the contents to and receives the information from the other servers 3, network servers, terminals 4, TV set 5 and audio set 6 to process the information. The computing unit 330 is provided with a server sending/receiving device (contents retrieving device) 331 also functioning as a program, a communication-status detector 332, an executability detector 333, a group information comparing device 334, a server reading device (reader) 335, a contents dispatcher 336, a dispatch controller 337 and a reproduce-processing device 338 (execution device).

The server sending/receiving device 331 is provided with the above-described network interface 33. The server sending/receiving device 331 processes the information in such a manner that the information can be sent to/received from the network interface 33.

The communication-status detector 332 detects a connection status of the terminal 4. In more detail, the communication-status detector 332 detects whether any terminal 4 is connected via the communication media 2 to the server 3 in such a state where the information can be sent/received. Whether the connection is established or not is determined by, for instance, whether all registered terminals 4 (three terminals are illustrated in FIG. 5 and FIG. 6 as an example) are connected or not.

Specifically, the server sending/receiving device 331 sends a predetermined request for a reply signal and receives a corresponding reply signal. Then, it is checked whether all individual information such as the product number and identification number for identifying the terminal 4 associated with the reply signal and registered in the storage unit 320 in advance is recognized or not.

The communication-status detector 332 also detects whether the contents is sent to the terminal 4 or not and records the information identifying the terminal 4 in the storage unit 320. When the communication-status detector 332 performs the detection, the connection status of the terminal 4 to which the contents has previously been sent is also checked.

Thus, the communication-status detector 332 checks whether the terminal 4 to which the contents has been sent is connected to the server 3 (as shown in FIG. 5) or is not connected to the server 3 (as shown in FIG. 6).

The executability detector 333 also checks whether the terminal 4 detected to be connected by the communication-status detector 332 has a license for executing the contents. More specifically, the executability detector 333 checks by the family tag if the terminal 4 has the same family tag or by the license information if the connected terminal 4, TV set 5 and audio set 6 are permitted to execute the contents.

The executability detector 333 checks whether the terminal 4 that is detected by communication-status detector 332 to have received the contents still stores the contents in the terminal contents database 42, and the stored contents is still executable. Specifically, the executability detector 333 checks whether the contents is still stored, already deleted, or when the contents remains, whether the contents data is corrupted and not executable. A signal according to the result of the executability check is output to the dispatch controller 337 or recorded in the storage unit 320.

The group information comparing device 334 compares the family tag stored in the terminal 4 that is detected by the communication-status detector 332 to be connected and the family tag stored in the group database 31 to check whether the both tags are identical. Specifically, a signal requesting the family tag is output by the server sending/receiving device 331 and the information received by the server sending/receiving device 331 in response to the signal is retrieved and compared with the family tag stored in the group database 31. After comparison, the group information comparing device 334 outputs a signal to the executability detector 333 and the dispatch controller 337 based on the result regarding the sameness.

The server reading device 335 reads and retrieves the contents stored in the terminal 4 by the server sending/receiving device 331 via the communication media 2 and, alternatively, the server reading device 335 retrieves the contents from the network server via a network to store in the storage unit 320. Incidentally when the contents is read from the terminal 4, the contents is streaming-output from the terminal 4 and the contents are left stored in the terminal 4 without being stored in the storage unit 320, which is reproduced by the reproduce-processing device 338.

When the contents is retrieved from the terminal 4, the contents stored in the terminal 4 is transferred to the storage unit 320 and stored therein so that the data is not kept in the terminal 4. When the contents is retrieved via the network, a copy of the contents stored in the network server is saved (i.e. downloaded) in the storage unit 320.

The contents dispatcher 336 reads the contents stored in the contents database 32 to send the data via the server sending/receiving device 331. The contents is sent to the corresponding terminal 4 based on the individual information for identifying the terminal 4 and a signal requesting the transmission of the contents. The contents is sent in such a manner that the encoded contents is copied and sent to the terminal 4 or the encoded contents is decoded to be reproduced directly by the reproducer 45 as streaming output without being stored in the terminal 4. The dispatch controller 337 decides in which form the contents is to be sent.

The dispatch controller 337 controls sending of the contents. More in detail, the dispatch controller 337 decides whether the contents is to be sent by the contents dispatcher 336 in response to the request. The decision is made based on the signal from the communication-status detector 332 and the signal from the executability detector 333 that reports the contents is executable, and the contents is sent according to the license information.

Specifically, based on the judgment by the communication-status detector 332 whether all the terminals 4 are connected or not, when all the terminals 4 are connected as shown in FIG. 5, the contents stored in the contents database 32 is decoded and sent to produce a streaming output so that the reproducer 45 can reproduce the contents in response to the request by the terminal 4, and the contents is copied and sent in an encoded format when the contents satisfies the licensed, for instance, copiable number of times or copiable period of time.

When the terminal 4 to which the contents has been previously sent is not connected as shown in FIG. 6: if parallel processing is not licensed, the dispatch controller 337 does not perform the streaming output even if the dispatch controller 337 detects a request from the terminal 4 or the dispatch controller 337 performs a process not to send a contents copy; if the parallel processing is licensed, the streaming output of the contents is produced, or, a copy of the contents is sent when it is determined that the sending operation is conducted within the number of licensed copiable times after subtracting the number of previous sending operation from the copiable number of times or, when the previously sent contents in no longer usable, adding the corresponding number of times to the copiable times.

When it is impossible to communicate with the terminal 4 to which the contents has been previously sent and to detect the existence and executability of the contents, it is determined that the contents is copied, for instance, once to the terminal 4, and the copying and producing streaming output are limited.

Incidentally, FIG. 5 illustrates an example of transmitting the contents licensed to copy only once, where, since the terminal 4 to which the contents has previously been sent is connected, the contents is regarded as being returned and streaming output of the contents is allowed while prohibiting the transmission of the contents copy to the other terminals 4. FIG. 6 illustrates another example of transmitting the contents licensed to copy only once, where, since the terminal 4 to which the contents has previously been sent is no connected, the contents is regarded as being taken out and the streaming reproduction of the contents by the other terminals 4 is prohibited. As described above, the dispatch controller 337 checks the connection status and executability based on the license information to decide whether the contents can be sent to the terminal 4 or not, allowing the contents dispatcher 336 to send the contents via the server sending/receiving device 331.

The reproduce-processing device 338 processes the contents read by the server reading device 335 from the terminal 4 and the network server and the contents is stored in the storage unit 320 and reproduced by the TV set 5 and audio set 6. The reproduce-processing device 338 encodes by using the family tag the contents distributed by the network server or retrieved from the terminal 4 for recording in the storage unit 320 and decodes the contents stored in the storage unit 320 for producing streaming output. The reproduce-processing device 338 is provided with the above-described encoder/decoder 34.

[3] Internal Arrangement of Terminal 4

The details of the internal arrangement of the terminal 4 will be described.

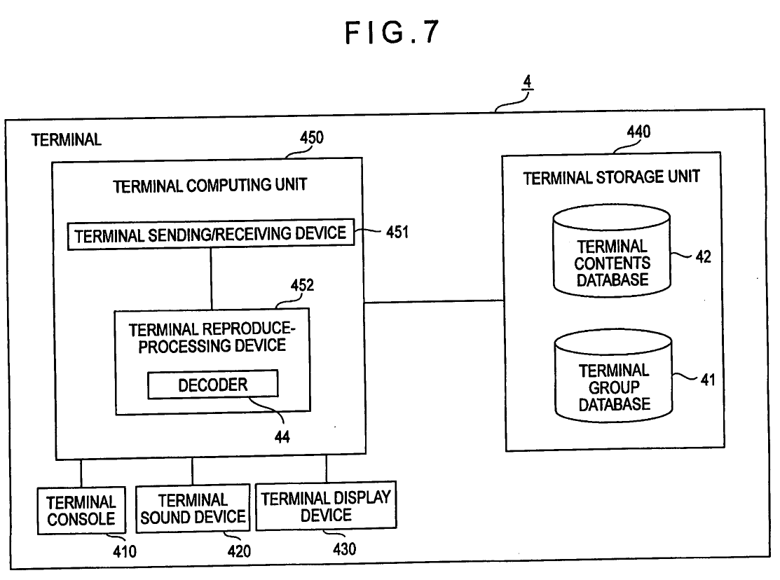

FIG. 7 schematically illustrates the arrangement of the terminal 4.

The terminal 4 includes a terminal console 410, a terminal sound device 420 and a terminal display device 430 (terminal execution devices), a terminal storage unit 440 and a terminal computing unit 450 as a computer. The terminal sound device 420 and the terminal display device 430 constitute the reproducer 45.

The terminal console 410 is provided with, for instance, buttons and controls (not shown) to be operated by a user like the console 310. Various operations of the terminal 4 can be set using the terminal console 410, including retrieving the contents distributed from another server, permitting the terminal sound device 420 and the terminal display device 430 to execute the contents stored in the terminal 4 and server 3, allowing the server 3 to execute the contents stored in the terminal 4, and transferring the contents stored in the terminal 4.

The terminal console 410 outputs predetermined signals to the terminal computing unit 450 in response to the user operations on the buttons and controls.

The terminal sound device 420 has a speaker (not shown). The terminal sound device 420 retrieves sound data such as music data and voice data output by the terminal computing unit 450 to aurally reproduce via the speaker after amplifying process.

The terminal display device 430 has a display panel (not shown). The terminal display device 430 retrieves visual data such as images and video pictures output by the terminal computing unit 450 to visually reproduce on the display panel.

The terminal storage unit 440 retrieves the information including the contents output from the terminal computing unit 450 to store the information. The terminal storage unit 440 is provided with the above-described terminal group database 41 and terminal contents database 42. Incidentally, the terminal storage unit 440 not only stores the group information and contents, but also readably stores the various information to be processed in a memory.

The terminal computing unit 450 sends the information including the contents to and receives the information from, for instance, the server 3 and network servers to process the information. The terminal computing unit 450 includes a terminal sending/receiving device (terminal information retrieving/transfer device) 451 and a terminal reproduce-processing device (terminal execution device) 452.

The terminal sending/receiving device 451 is provided with the above-described terminal network interface 43. The terminal sending/receiving device 451 processes the information in such a manner that the information can be sent to/received from the terminal network interface 43

The terminal reproduce-processing device 452 processes the contents stored in the terminal contents database 42 or the contents produced as streaming output from the server 3 to reproduce by the terminal sound device 420 and terminal display device 430. The terminal reproduce-processing device 452 decodes the encoded contents sent by the server 3 to store in the terminal contents database 42. The terminal reproduce-processing device 452 is provided with the above-described decoder 44.

The terminal reproduce-processing device 452 retrieves the contents distributed by a network server via a network to store in the terminal contents database 42. The terminal reproduce-processing device 452 also transfers the contents stored in the terminal contents database 42 to the server 3. Specifically, the terminal reproduce-processing device 452 sends the contents stored in the terminal contents database 42 to the server 3 by the terminal sending/receiving device 451 and deletes the contents in the terminal contents database 42. The terminal reproduce-processing device 452 reads the contents stored in the terminal contents database 42 based on the request from the server reading device 335 of the server 3 to produce streaming output.

[4] System Function

It will be described how the contents processing system 1 works with reference to the flowcharts. Incidentally, the contents processing system 1 works differently depending on whether the contents processing system 1 receives a copy request or a streaming output request, so the operations in response to the respective requests will be described below.

(4-1) Copy Request from Terminal 4

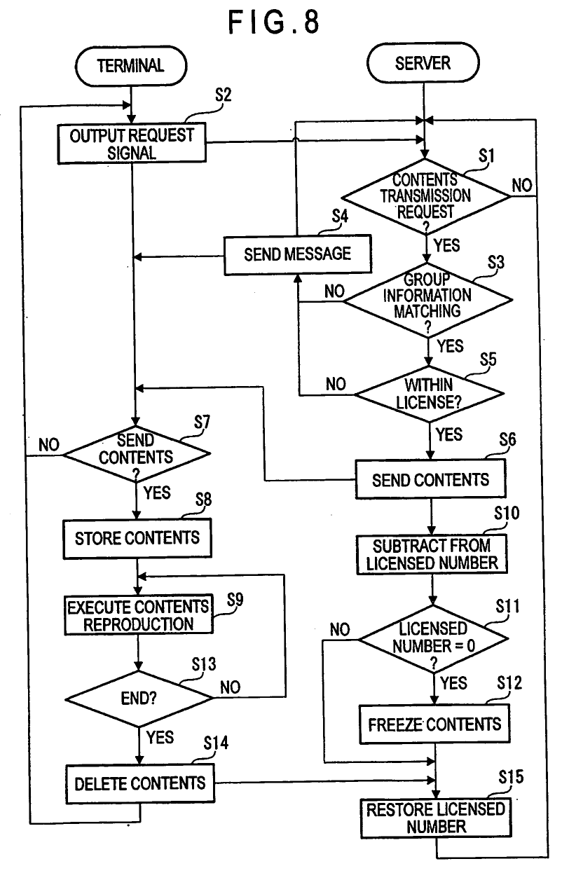

When the copy request is sent by the terminal 4, the contents is sent from the server 3 to the terminal 4 according to the flowchart of FIG. 8.
(1) The server 3 detects whether the request signal for contents transmission is sent by the terminal 4 and is in standby for the request for the transmission (step S1).
(2) When the request signal for contents transmission is sent by the terminal 4 (step S2), the server 3 compares the group information of the requesting terminal 4 with the group information stored in the group database 31 by the group information comparing device 334 (step S3). Specifically, according to the signal output by a predetermined operation on the terminal console 410, the terminal computing unit 450 generates a signal for requesting contents transmission that integrally contains a signal requesting a predetermined contents and individual information for identifying the terminal 4 such as the terminal product number or identification number stored in the terminal storage unit 440 to be sent to the server 3 via the communication media 2. The group information comparing device 334 of the server 3 generates a request signal for family tag transmission addressed to the terminal 4, which is output by the server sending/receiving device 331 to the terminal 4 and then the group information comparing device 334 makes a comparison using the family tag sent by the terminal 4. Incidentally, if no information is sent by the terminal 4 even after a predetermined number of request signals has been sent or a predetermined period of time has elapsed, the group information comparing device 334 determines that the terminal 4 does not have an execution license.
(3) If the group information comparing device 334 determines that both family tags do not correspond with each other, the server 3 determines the request signal was sent by a terminal 4 that does not have an execution license and sends to the terminal 4 a display or sound output signal containing a message informing that the contents can not be sent (Step S4).
(4) If the group information comparing device 334 determines that both family tags correspond with each other, the dispatch controller 337 of the server 3 determines whether a contents copy can be sent in reference to the licensed number of the requested contents stored in the contents database 32 (Step S5). Specifically, the dispatch controller 337 searches the terminals 4 and obtains the number of the terminals 4 to which the contents copy has been sent, and based on the value found by subtracting the number from the licensed number in the contents database 32, determines whether the contents transmission is restricted or not (Step S4). For instance, if the licensed number is two and the contents copy has been sent to two terminals 4, the dispatch controller 337 determines a further copy can not be sent and sends a message informing accordingly as a signal to the terminal 4 that output the request signal (Step S4).
(5) On the other hand, for instance, if the licensed number is two and a contents copy has been sent to one terminal 4 only, where a part of the licensed number is left, the dispatch controller 337 determines the contents copy can be sent and the encoded copy of the subject contents is sent to the terminal 4 by the contents dispatcher 336 via the server sending/receiving device 331 (Step S6).
(6) In the meanwhile, the terminal computing unit 450 of the terminal 4 is waiting for a reply from the server 3 and monitoring whether the reply contains the contents or not (Step S7). When detecting that the contents has been sent by the server 3, the terminal computing unit 450 stores the forwarded contents in the terminal contents database 42 (Step S8).
(7) When the terminal 4 is operated to designate the contents for executing reproducing operation, the terminal reproduce-processing device 452 decodes the subject contents stored in the terminal contents database 42 by the decoder 44 to execute the reproduction process (Step S9).
(8) Thus, when it becomes possible to execute the move reproduction or copy reproduction on the terminal 4, and since the contents has been sent to one terminal 4, the dispatch controller 337 of the server 3 subtracts one from the remaining licensed number in the resident memory (Step S10). Then, the dispatch controller 337 determines whether the subtracted remaining licensed number is zero or not (Step S11). If it is zero, the dispatch controller 337 determines that a further copy can not be sent and freezes the contents reproduction and transmission so that the contents becomes unexecutable (Step S12).
(9) When the user of the terminal 4 wants to finish the use of the received contents by operating the console of the terminal 4, where the user inputs a command to finish the use of the contents in the terminal contents database 42 (Step S13), the terminal computing unit 450 deletes the contents from the terminal contents database 42 and sends a corresponding message to the server 3 (Step S14).
(10) When the server 3 receives the message that the contents has been deleted from the terminal 4, the dispatch controller 337 restores the remaining licensed number by one (Step S15).
   (4-2) Streaming Output Request being Sent by Terminal 4

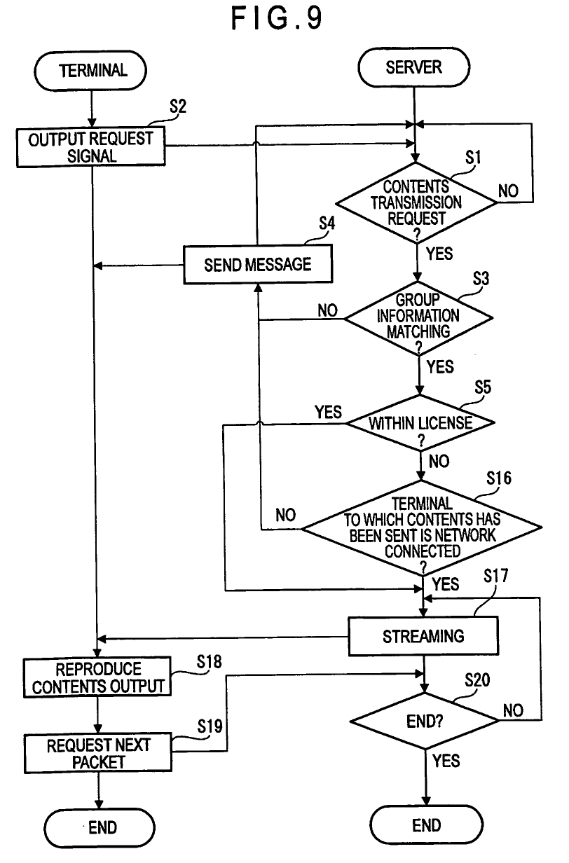

When the streaming output request is sent by the terminal 4, the contents is sent from the server 3 to the terminal 4 based on the flowchart of FIG. 9.
(1) The waiting status of the server 3 (Step S1), the output of the request signal from the terminal 4 (Step S2), the comparison of group information (Step S3) and the message transmission (Step S4) are similar to those in (4-1) described above, so that the description will be omitted.
(2) The dispatch controller 337 of the server 3 determines, as described above, whether the contents can be sent in reference to the licensed number of the requested contents (Step S5). If it is determined that the contents transmission is within the licensed number, the process goes to the phase of streaming reproduction described below.
(3) If the copy of the subject contents has already been sent to the other terminal 4 in the above-described Step S5, where it is determined that the remaining licensed number is zero, the dispatch controller 337 determines whether the other terminal 4 to which the contents copy has been sent is currently connected to and communicationable with the network including the server 3 (Step S16). If the other terminal 4 to which the contents copy has been sent is not connected to the server 3 via the communication media 2, the dispatch controller 337 sends the terminal 4 a message informing that streaming reproduction is not possible (Step S4). Incidentally, if the licensed number is two and neither of the two terminals 4 to which the contents copy has been sent is connected, the dispatch controller 337 determines that there is not a connection, while if at least one of the two terminals 4 is connected, the dispatch controller 337 determines that the terminal 4 to which the contents copy has been sent is connected. FIG. 6 shows the former case and FIG. 5 shows the latter case. The connection to the server 3 via the communication media 2 can be a home LAN including the server 3 and communication connections of a short-distance such as ad-hoc connections that temporarily and wirelessly connect to the server 3, and may not include such connections as the Internet connections via public lines.
(4) If the dispatch controller 337 determines that the terminal 4 to which the contents has been sent is connected via the communication media 2, the reproduce-processing device 338 of the server 3 reproduces the subject contents in the contents database 32 by the encoder/decoder 34, while simultaneously producing streaming output to the terminal 4 sequentially in packets (Step S17).
(5) The terminal 4 buffers the packets that are received as streaming output, while sequentially reproducing the output (Step S18) and requesting the streaming output of the next packet (Step S19).
(6) The above-described (4) and (5) are repeated by the end of the contents to be reproduced as streaming output and the streaming output ends when the contents comes to the end.
   (4-3) Reproduction of Contents Stored in Terminal 4 in Another Server

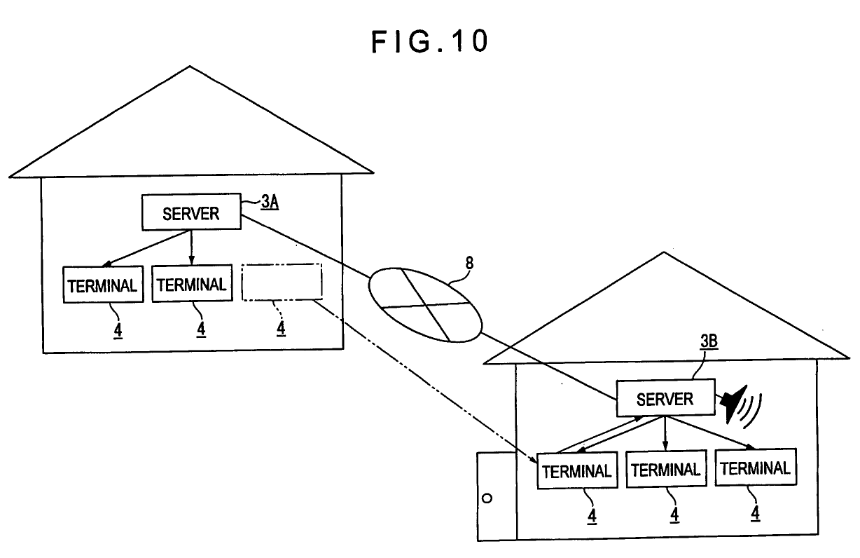

Like an example shown in FIG. 10, when the contents stored by copying or moving from a server 3A to the terminal 4 that has the family tag identical with the server 3A or downloaded independently by the terminal 4 are reproduced in another server 3B, the contents can be reproduced (a) as streaming output in the terminal 4 serving as a contents server or (b) in the other server 3B by moving the contents from the terminal 4 to the other server 3B.

(a) Reproduction of Contents Stored in Terminal 4 as Streaming Output in Another Server 3

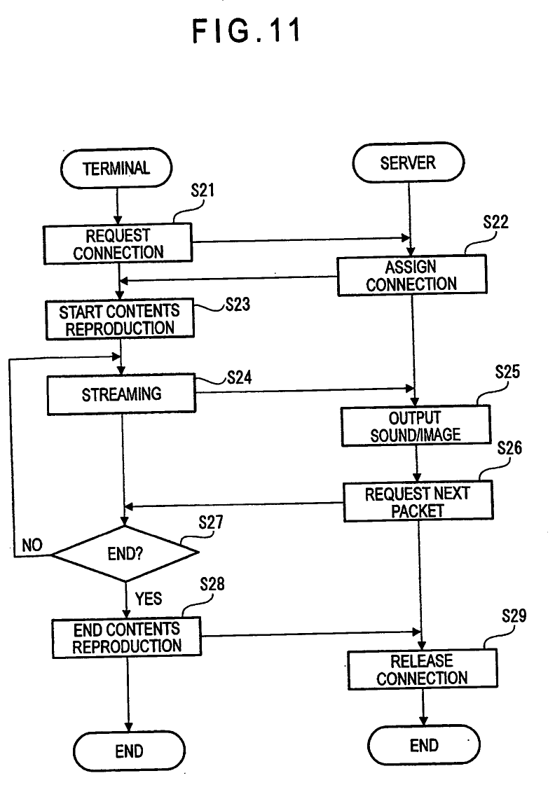

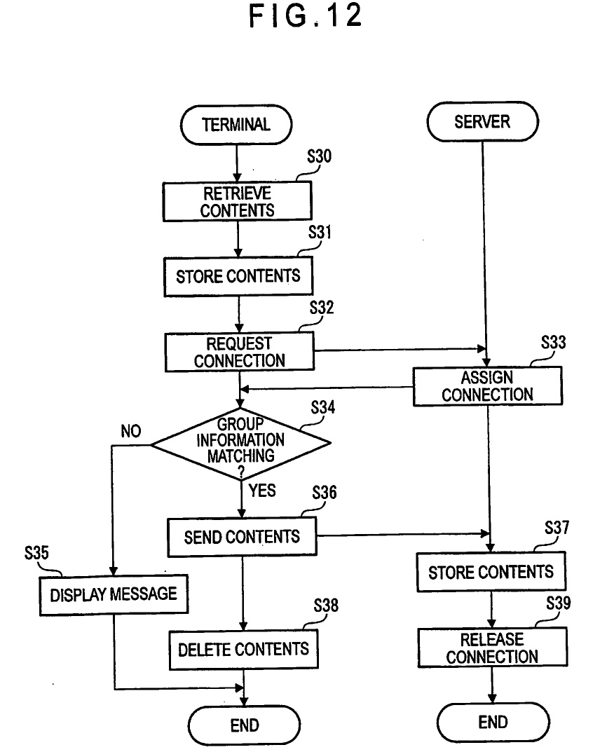

In this case, the streaming reproduction is performed based on the flowchart shown in FIG. 11.
(1) When the user operates the terminal 4 to request a connection for streaming reproduction, the terminal sending/receiving device 451 of the terminal 4 outputs a connection request signal to request a connection to the network including the server 3B (Step S21). The server 3B assigns a connection to the connection request and outputs a corresponding acceptance signal informing that the connection is established. Incidentally, in this phase, the server 3B only recognizes that streaming reproduction will be performed, but does not make a family tag inquiry and the like.
(2) When the connection is established, the terminal 4 decodes the contents stored in the terminal contents database 42 by the decoder 44 of the terminal reproduce-processing device 452 to start the reproduction of the contents (Step S23). When the contents reproduction starts, the terminal sending/receiving device 451 reproduces the contents as streaming output per packets (Step S24).
(3) In the server 3B, while buffering the packets received as streaming output, the contents sent by the terminal 4 is sequentially reproduced by the speaker or on the image display connected to the server 3B, where streaming output of the subsequent packet is requested to the terminal 4 simultaneously with the reproduction process (Step 26).
(4) The above-described (2) and (3) are repeated by the end of the contents to be reproduced in the terminal 4 (Step S27) and when the contents reproduction ends, the terminal sending/receiving device 451 of the terminal 4 outputs a corresponding message to the server 3B (Step S28).
(5) On the server 3B side, when receiving the signal informing that the contents reproduction has ended, the connection with the terminal 4 is disconnected (Step S29).
   (b) Moving Contents Obtained by Terminal 4 to Server 3B for Reproduction

In this case, the move reproduction is performed based on the flowchart shown in FIG. 12.
(1) The terminal 4 is directly connected to, for instance, a network 8, to access a predetermined site on the Internet, the contents can be retrieved by downloading (Step S30) and the retrieved contents is stored in the terminal contents database 42 of the terminal 4 (Step S31).
(2) When the user operates the terminal 4 to request a connection to the server 3B, the terminal computing unit 450 outputs a signal to request the connection (Step S32), which is received by the server sending/receiving device 331 of the server 3B (Step S33), and the server 3B outputs to the terminal 4 an acceptance signal containing the family tag (the group information of the server 3B).
(3) The terminal computing unit 450 of the terminal 4 that has received the acceptance signal determines whether the family tag of the server 3B contained in the acceptance signal corresponds with the family tag stored in the terminal group database 41 thereof or not (Step S34). When the both family tags do not correspond with each other, a message is displayed on the terminal display device 430 of the terminal 4 and the process is terminated (Step S35).
(4) When the terminal computing unit 450 determines that the both family tags correspond with each other, the terminal sending/receiving device 451 sends the subject contents to the server 3B (Step S36).
(5) The sent contents is accepted by the server sending/receiving device 331 of the server 3B and stored in the contents database 32 (Step S37).
(6) When the terminal computing unit 450 of the terminal 4 finishes the contents transmission, the contents stored in the terminal contents database 42 is deleted and the process is terminated (Step S38). On the other hand, on the server 3B side, when the forwarded contents is completely stored, the connection is disconnected and the process is terminated (Step S39).
   [5] Advantages of Embodiment

According to the present embodiment described above, the following advantages can be obtained.

The contents is executably copied and sent via the communication media 2 only to the terminal 4 that has the family tag (group information) for identifying a group in which the contents can be shared and executed such as a family, a company department and a private circle. If it is recognized that the terminal 4 to which the contents has been sent is not connected by the communication-status detector 332 in such a manner that the data can be sent/received, the contents is regarded as being taken out, where the transmission of the contents stored in the contents database 32 to the other terminal 4 connected in such a manner that the data can be sent/received via the communication media 2 is limited (copying and producing streaming output are prohibited so that the execution becomes impossible), or based on the contents license information, another copying or producing streaming output are executably performed.

Thus, the contents execution can be appropriately controlled in correspondence with the contents execution limit, so that the contents can be appropriately protected while improving the convenience for the user.

The terminal sound device 420 and the terminal display device 430 are provided such that the contents sent by the contents dispatcher can be executed in a state that the terminal 4 is not connected via the communication media 2 in such a manner that the data can be sent/received.

Hence, especially in the arrangement where the retrieved contents is executable independently from the server 3, the contents can be appropriately protected. Since the terminal 4 can independently execute the contents, it is possible to carry the terminal 4 for execution in outside, thereby improving the flexibility for contents usage and further improving the convenience for the user.

In the server of the present invention, when the contents identical with the contents stored in the contents storage is sent by the contents dispatcher, if it is recognized by the communication-status detector that the terminal to which the contents has been sent is not connected, it is desirable that the dispatch controller restricts the contents transmission to the other terminal.

Thus, when the terminal to which the contents has been sent is not connected, considering that the contents has been taken out, the contents transmission is restricted so that the contents can not be executed on the other terminal, thereby securely protecting the contents.

In the contents processing system of the present invention, it is desirable to use the above-described contents processor according to the second aspect of the present invention as a terminal.

Hence, the contents can be more appropriately protected while the convenience for the user can be improved.

When the contents identical with the contents stored in the contents database is sent by the contents dispatcher 336, if it is recognized by the communication-status detector 332 that the terminal 4 to which the contents has been sent is not connected, it is prohibited based on the license information that the dispatch controller 337 sends (permits copying or produces streaming output of) the contents to the other terminal 4.

Accordingly, when the terminal 4 to which the contents has been sent is not connected, considering that the contents has been taken out, as with the case where a CD is taken out, the contents transmission is restricted so that the contents can not be executed by the other terminal 4, thereby the contents can be strictly protected.

It is judged by the executability detector 333 whether the contents that has been sent is executable or not on the terminal 4 and, when not executable, the contents can be sent to the other terminal 4.

When the contents is not executable because, for instance, the contents was deleted by the terminal 4 that retrieved the contents and judged it unneeded or the contents data is damaged due to the usage conditions, the contents is not executed on the other terminal 4, so that by allowing the other terminal 4 to execute the contents, operations and processes such as retrieving the contents redistributed from the server and re-storing from the TV set 5 and audio set 6 can be eliminated, thereby further improving the convenience for the user.

In the server of the present invention, it is also desirable that the contents can be sent to the other terminal if the contents is detected unexecutable when judging whether the contents that has been sent is executable on the terminal or not.

Accordingly, when the contents sent to the terminal is not executable because, for instance, an error has occurred or the contents has been deleted, by allowing the transmission of the contents stored in the contents storage to the terminal, the terminal can execute the contents again, or by sending the contents to the other terminal, it is prevented that the other terminal can not execute the contents, thereby improving the usability for the user.

As contents execution license, the license information regarding the number of the terminals that can parallelly execute the contents (such as the copiable number of times of the contents and whether streaming output is allowed or not) is integrally provided to the contents, and by subtracting the number of times that the contents has been sent to the terminal 4 from the licensed number of the license information, it is judged whether the number of previous transmissions equals to the number set in the license, and if the license conditions are satisfied, the contents can be sent to the terminal 4 requesting the transmission.

Hence, in correspondence with the license information regarding the contents execution license, the contents can be appropriately sent for execution, so that the contents can be appropriately used by simple computing process.

In the server of the present invention, it is also desirable that the license information counting the number of the terminals that can parallelly execute the contents is provided to the contents, and by subtracting the number of times that the contents has been sent to the terminal from the number contained in the license information, the contents can be sent to the connected terminals in accordance with the number resulted from the subtraction.

Accordingly, if a copiable number of times is set as the license information, the contents can be sent the number of times to the terminal for execution, and in correspondence with the license information regarding the contents execution, the contents can be appropriately sent for execution, so that the contents can be appropriately used by simple computing process.

Based on the license information and in accordance with the transmission request from the terminal 4, whether the contents can be sent or not is determined. Thus, the contents is appropriately transmitted for each transmission request, so that the contents can be strictly protected.

Incidentally, even if the transmission requests are sent substantially at the same time by a plurality of terminals 4, by the computing process in accordance with the licensed number, processes can be collectively performed, thereby easily improving the processing efficiency.

Regarding the contents transmission requests, whether the contents can be sent or not is determined based on the license information in accordance with whether it is a copy (download) request or streaming output request. Thus, how to send contents is set in accordance with the usage conditions of the contents, where the contents can be appropriately sent within the license conditions in accordance with the usage conditions, thereby protecting the contents while improving the convenience for the user.

If it is recognized by the communication-status detector 332 that the terminal 4 in which the previously sent contents is executably stored is connected via the communication media 2 in such a manner the data can be sent/received, or that the terminal 4 to which the contents has been sent can not execute the contents, the number of the connected terminals 4 recognized to be subtracted from the executable number of the license conditions is added, i.e. the number of the terminals to which the contents can be sent is increased by the number of the connected terminals 4.

Hence, when the terminal 4 in which the previously sent contents is executably stored is connected to the server 3, the taken-out contents is regarded as having been returned, where the execution license conditions eases by the number so that the other terminal 4 can execute the contents. Accordingly, in an environment where the contents is controlled only by the number of execution times and appropriately used, it becomes possible to prevent inconvenience such as interruption of the contents, and the contents can be appropriately executed in correspondence with the license information, while protecting and appropriately using the contents as well as improving the usability and convenience for the user.

When the contents is sent, the process is performed for updating history information as well as the individual information for identifying the terminal 4 to which the contents is sent each time of transmission. When it is judged whether the contents can be sent based on the license information, the terminals 4 to which the contents has been previously sent are easily identified based on the history information, so that it can be easily recognized whether the terminals in which the previously sent contents is executably stored are connected or not, thereby improving the processing efficiency.

The server 3 is adapted to retrieve the contents via the network by the server sending/receiving device 331 and store the contents in the contents database 32.

Thus, when the contents is distributed via the network, without employing complicate processes for encoding and decoding, the contents can be appropriately protected using family tags, thereby easily improving the convenience for the user. The processing load for encoding and decoding and the load for distributing the contents via the network can be easily decreased.

Especially, the easily copiable contents compressed by, for instance, MP3 (MPEG (Motion Picture Expert Group) audio layer 3) and distributed via the network can be easily and appropriately protected.

Therefore, in the server of the present invention, it is desirable that the contents distributed via the network is retrieved by the contents retrieving device and stored in the contents storage.

Thus, even when the contents is distributed via the network, without employing complicate processes for encoding and decoding, the contents can be appropriately protected while the convenience for the user can be improved and the processing load for encoding and decoding and the load for distributing the contents via the network can be easily decreased.

Further, based on the predetermined operations on the console 310, the server 3 is able to execute the contents stored in the contents database 32 and the contents output as streaming data via the communication media 2 from the terminal 4 to be read by the server reading device 335 with the connected TV set 5 and audio set 6. Thus, without limiting to the execution on the terminal 4, the server 3 also can execute the contents, where the usage flexibility and convenience for the user are improved.

Additionally, when the contents which has been previously sent to the terminal 4 and is left executable is to be executed by the TV set 5 and audio set 6, if it is recognized based on the license information that the terminal 4 is not connected, the contents execution is limited or restricted in some circumstances. Accordingly, when the contents has been sent to the terminal 4 in an executable manner, considering that the contents has been taken out, the execution of the contents on the TV set 5 and audio set 6 is restricted, thereby more appropriately protecting the contents.

In the server of the present invention, it is also desirable that an execution device for executing the contents stored in the contents storage is provided and when the Communication-status detector detects that the terminal to which the contents has been sent by the contents dispatcher is not connected in such a manner the information can be sent and received, the contents execution is restricted.

Accordingly, the contents can be executed by other than the terminal, thereby improving the usage flexibility and convenience for the user. If the contents is sent to the terminal, the contents is regarded as being taken out, such that the contents execution by the execution device is limited by, for instance, permitting the execution only when the contents can be executed by streaming output or allowing the execution according to the execution license if the copiable number of times is preset, thereby appropriately protecting the contents.

The system is arranged so that the contents is collectively managed by the server 3 and is sent to the designated terminal 4 as necessary.

Thus, the convenience can be improved by, for instance, carrying the terminal 4 to allow the execution of the contents in the outside area while restricting the transmission of the contents in accordance with the group information allocated to the terminal 4, so that the contents can be sufficiently protected with a simple arrangement with improved convenience for the user.

In the contents processing system of the present invention, it is desirable that a reader for reading the contents stored in the terminal connected via the communication media and an execution device for executing the contents read by the reader are provided in the server.

Hence, the contents stored in the terminal can be executed even when, for instance, the terminal is taken out to the outside area by connecting to the server that has different group information to execute the contents stored in the terminal by the server, thereby improving the flexibility for the contents usage and the convenience for the user.

In the contents processing system of the present invention, it is also desirable that the servers can send to and receive from information therebetween via a network, and when the group information stored in the group information storage of a server corresponds with the group information stored in another server or a terminal connected to the other server, the contents stored in the contents storage can be executed on the other terminal connected via the communication media.

Accordingly, the flexibility for setting a group that can execute the contents is improved and the contents availability in correspondence with the contents execution limit is also improved, thereby improving the convenience for the user.

The terminal 4 is able to retrieve the contents via the network and transfer the contents to the server 3.

The contents can be retrieved in the outside area with the carried terminal 4, which can be executed within the same group, so that the convenience can be further improved while appropriately protecting the contents by transferring the contents to the server 3 leaving no contents in the terminal 4 and allowing no execution and further transfer of the contents.

In the server of the present invention, it is desirable that the terminal is able to retrieve the contents via the network by the terminal information retrieving device and the retrieved contents is transferred via the communication media to the contents storage.

Accordingly, the contents can be retrieved by the terminal, so that the convenience for the user is improved, and by transferring the contents retrieved by the terminal to the contents storage, the contents can be used by the other terminal while being protected, thereby further improving the convenience for the user.

In the contents processing system of the present invention, it is also desirable that the contents distributed via the network can be retrieved by the terminal sending/receiving device of the terminal and the contents retrieved in the terminal is transferred by a transfer device via the communication media to the contents storage of the server.

Thus, the contents can be retrieved by the terminal such that the convenience for the user is improved, and the contents retrieved by the terminal can be transferred to the contents storage such that the contents becomes available on the other terminal while protecting the contents, thereby further improving the convenience for the user.

[6] Modifications of Embodiment

Though the present invention has been described above with reference to a preferred embodiment, the scope of the present invention is not limited to the embodiment but includes various improvements and variations in the design as long as an object of the present invention can be achieved.

For instance, the contents to be executed may be not only the data to be reproduced such as above-described music data, voice data, image data and video pictures, but may include any data such as video games and application softwares.

The server 3 may retrieve the contents not only from the network server via the network, but also, for instance, by reading the contents reproduced by the TV set 5, the audio set 6 and the like or by reading the contents stored in the terminal 4.

In determining whether the contents is sent or not, the download request and the streaming output request may not be judged in accordance with the transmission request of the contents as shown in FIG. 7, but may be judged by initially recognizing a transmission request designated by the user and separately processing the download and streaming output operations in accordance with the download request and the streaming output request.

Further, whether it is possible to send or not is judged based on the license information, but the license conditions may not be provided to the contents, or the license conditions may not be judged and the contents may be treated like a single storage media such as a CD. That is to say, a method similar to the one in which the music contents stored in a CD is copied to a MD can be employed. Incidentally, as described above, by judging whether the contents can be sent or not based on the license information, the contents can be more appropriately protected and efficiently used.

Though the communication status is detected by the communication status detector 332 and whether the contents is sent or not is appropriately determined by judging whether the forwarded contents is executable or not by the executability detector, the communication status and whether the contents is sent or not may be judged, for instance, by a single processing device.

Incidentally, the present invention may not be embodied as a program, but any arrangements including an electrical circuit, a single element, or a network in which respective components are constructed by computers that are connected with each other may be employed. That is to say, the computer of the present invention is not limited to a single computer, but may include other arrangements such as the network, single element and electrical circuit.

By adopting the program arrangement, it easily becomes possible, for instance, that the built program is read by a computer and the computer serves as the server 3 and terminal 4, thereby easily obtaining the expansion in use, improved productivity and cost reduction. And by adopting the arrangement where the program is computer-readably stored in a storage medium such as a memory and optical disk, the program is easily read by the computer as described above, and the program arrangement can be easily handled, thereby easily obtaining the expansion in use.

The contents is stored after encoding by the group information, but the contents may be simply stored, where whether the contents is sent or not is judged by the identity of the group information. By encoding the contents before storing, even when the encoded contents is sent in response to a transmission request, the contents cannot be decoded and executed on account of the different group information, so that the same advantage as determining the identity of the group information by the group information comparing device 334 can be obtained.

Further, by the both processes of encoding the contents and judging the identity of the group information, the contents can be protected more securely.

The number of times that the contents is sent may not be calculated, but if, for instance, the period of time that the contents can be used is set as the license information, a timer for keeping the current time may be provided so that whether the contents is sent or not may be judged based on the usage period and the time kept by the timer. Likewise, any arrangement is possible as long as whether the contents is sent or not is judged in accordance with the license conditions.

The contents distributed from the network server can also be retrieved by the terminal 4 via the network, but it can be so arranged that the contents is retrieved only by the server 3, or the contents is not retrieved via the network.

Further, it may be so arranged that only the terminal 4 can retrieve the contents from the network server.

A server function as in the server 3 may be provided to the terminal 4 to control the contents. For instance, the terminal 4 may be used to license or restrict the transmission of the contents (checkout control). It is effective especially in the arrangement in which the contents is retrieved from the Internet by the terminal 4.

When the contents retrieved by the terminal 4 is transferred to the server 3, though the contents is sent only to the server 3 that has the same group information, the contents may be sent when the group information is not identical or may be transferred to another terminal 4. When the contents is sent to the devices that have the different group information, the contents is regarded as being given.

When the contents is passed over, in the same manner as transferring the contents described above, the group information is rewritten and the contents in the sender is deleted.

However, when the contents is transferred to the server 3 that has the different group information, as for the contents that is limited against copying by the license information, it is necessary to perform processing so that the contents copied from the server 3 that has the identical group information can not be transferred. For instance, to the contents transferred from the server 3, flag information can be integrally associated so that the contents cannot be re-transferred.

In the present embodiment copying of the contents may not be limited to only once, but copying of the contents may be possible for predetermined times or copying of the contents may be possible only in a predetermined period of time.

Additionally, in the above-described (4-1), the licensed number is restored, by informing the server 3 from which the contents is copied that the contents stored in the terminal 4 has been deleted, but the present invention is not limited thereto.

As shown in FIG. 10, when the server 3A and server 3B are connected via the network 8, each of the family tags is provided with a link such as “parent and child” and “sibling” and the contents stored in the terminal 4 is copied from the server 3A, it is informed to the server 3B that the contents stored in the terminal 4 has been deleted, which is recognized by the server 3B, where the server 3B informs the server 3A of the receipt of the message to restore the licensed number of the subject contents in the contents database of the server 3A.

The priority application Number JP2004-160838 upon which this patent application is based is hereby incorporated by reference.

1. A server for storing contents and sending various information including the contents via communication media in such a manner that the information can be sent and received and the contents can be executed in at least one terminal connectable to the server, the server comprising:
a contents storage for storing the contents;
a group information storage for storing group information for identifying a group that can execute the contents;
a communication-status detector for detecting a status whether the information can be sent to and received from the terminal via the communication media;
a contents dispatcher for executably sending the contents only to the terminal storing the group information via the communication media; and
a dispatch controller for restricting a transmission of the contents by the contents dispatcher via the communication media to the other terminal connected in such a manner that the information can be sent and received when the communication-status detector detects that the terminal to which the contents has been sent by the contents dispatcher is not connected in such a manner that the information can be sent and received.

2. The server according to claim 1,
wherein the contents dispatcher sends contents identical with the contents stored in the contents storage; and
the dispatch controller restricts a transmission of the contents to the other terminal when the communication-status detector detects that the terminal to which the contents has been sent is not connected.

3. The server according to claim 2,
wherein the terminal includes an executability detector for judging whether the contents sent by the contents dispatcher is executable or not; and
the dispatch controller permits the transmission of the contents by the contents dispatcher when the executability detector judges that the contents is not executable on the terminal.

4. The server according to claim 1,
wherein the contents has a license information counting the number of the terminals that can parallelly execute the contents; and
the dispatch controller subtracts a number of times that the contents dispatcher has sent the contents to the terminal from the number contained in the license information, the dispatch controller permitting in accordance with the number resulted from the subtraction the transmission of the contents stored in the contents storage to the terminal connected in such a manner that the information can be sent and received.

5. The server according to claim 4,
wherein the dispatcher controller restores the subtracted licensed number when the communication-status detector recognizes that the terminal to which the contents has been sent can not execute the contents in detecting the terminal to which the contents has been sent is connected in such a manner that the information can be sent and received.

6. The server according to claim 1, further comprising:
a contents retrieving device for retrieving the contents distributed via a network and storing the contents in the contents storage.

7. The server according to claim 1, further comprising:
an execution device for executing the contents stored in the contents storage;
wherein the execution device restricts an execution of the contents when the communication-status detector detects that the terminal to which the contents has been sent by the contents dispatcher is not connected in such a manner that the information can be sent and received.

8. A contents processor that can be connected to a server storing contents via communication media in such a manner that various information including the contents can be sent and received and executes the contents sent by the server, the contents processor comprising:
a terminal information retrieving device for retrieving the information via the communication media;
a terminal group information storage for identifying a group that can execute the contents and storing group information corresponding to the group information stored in the server;
a terminal contents storage for storing the contents that the terminal information retrieving device has retrieved from the server to which the group information corresponds; and
a terminal execution device for reading and executing the contents stored in the terminal contents storage or the contents stored in the server to which the group information corresponds via the communication media.

9. A contents processing system comprising:
a server for storing contents and at least one terminal connectable to the server via communication media in such a manner that various information including the contents can be sent and received,
wherein the terminal comprises:
a terminal sending/receiving device for sending and receiving the various information via the communication media;
a terminal contents storage that can store the contents sent by the server,
a terminal group information storage for storing group information for identifying a group that can execute the contents; and
a terminal execution device for executing the contents,
wherein the server comprises:
a contents storage for storing the contents;
a group information storage for storing the group information;
a communication-status detector for detecting a status whether the information can be sent to and received from the terminal via the communication media;
a contents dispatcher for sending the contents only to the terminal storing the group information via the communication media in such a manner that the contents can be executed by the terminal execution device; and
a dispatch controller for restricting the transmission of the contents by the contents dispatcher via the communication media to the other terminal connected in such a manner that the contents can be sent and received when the communication-status detector detects that the terminal that can execute the contents by the terminal execution device is not connected in such a manner that the information can be sent and received.

10. The contents processing system according to claim 9,
wherein the terminal comprises a transfer device for transferring the contents stored in the terminal contents storage to the contents storage via the communication media.

11. The contents processing system according to claim 9,
the server further comprising:
a reader for reading the contents stored in the terminal connected via the communication media; and
an execution device for executing the contents read by the reader.

12. The contents processing system according to claim 9,
wherein the server can send to and receive from another server via a network the various information and permits the other terminal connected via the communication media to execute the contents stored in the contents storage, when recognizing that the group information corresponding to the group information stored in the group information storage is stored in the other server and the terminal connected to the other server.

13. A contents processing method for sending contents stored in a contents storage in such a manner that various information including the contents is executably sent to and received from at least one terminal via communication media, the method comprising:
detecting whether the information can be sent to and received from the terminal via the communication media;
detecting whether the terminal connected via the communication media has the group information corresponding to the group information for identifying the group that can execute the contents;
detecting whether the terminal connected via the communication media executably stores the contents; and
limiting the transmission of the contents via the communication media to the other terminal connected in such a manner that the information can be sent and received when recognizing that the terminal that executably stores the contents is not connected in such a manner that the information can be sent and received.

14. A contents processing method for executing the contents sent by the server,
wherein a terminal can be connected to a server storing contents via communication media in such a manner that information including the contents can be sent and received, the method comprising:
detecting whether the information can be sent to and received from the server via the communication media;
storing the contents sent by the server that stores the group information corresponding to the group information stored in advance for identifying the group that can execute the contents;
reading and executing the stored contents and the contents sent by the server that stores the group information corresponding to the group information via the communication media.

15. A program executed on a computer for contents processing, wherein the computer serves as the server for storing contents and sending various information including the contents via communication media in such a manner that the information can be sent and received and the contents can be executed in at least one terminal connectable to the server;
wherein the server comprises:
a contents storage for storing the contents;
a group information storage for storing group information for identifying a group that can execute the contents;
a communication-status detector for detecting a status whether the information can be sent to and received from the terminal via the communication media;
a contents dispatcher for executably sending the contents only to the terminal storing the group information via the communication media; and
a dispatch controller for restricting a transmission of the contents by the contents dispatcher via the communication media to the other terminal connected in such a manner that the information can be sent and received when the communication-status detector detects that the terminal to which the contents has been sent by the contents dispatcher is not connected in such a manner that the information can be sent and received.

16. A program executed on a computer for contents processing,
wherein the computer works as the contents processor that can be connected to a server storing contents via communication media in such a manner that various information including the contents can be sent and received and executes the contents sent by the server,
wherein the contents processor comprises:
a terminal information retrieving device for retrieving the information via the communication media;
a terminal group information storage for identifying a group that can execute the contents and storing group information corresponding to the group information stored in the server;
a terminal contents storage for storing the contents that the terminal information retrieving device has retrieved from the server to which the group information corresponds; and
a terminal execution device for reading and executing the contents stored in the terminal contents storage or the contents stored in the server to which the group information corresponds via the communication media.
